(19) United States
(12) Patent Application Publication
(10) Pub. No.: US 2010/0099424 A1
(43) Pub. Date: Apr. 22, 2010

(54) INTERFERENCE CONTROL IN A MOBILE NETWORK STRUCTURE WITH PRIVATE PICO/HOME BASE STATIONS

(76) Inventor: Angelo Centonza, Winchester (GB)

Correspondence Address: STAAS & HALSEY LLP, SUITE 700, 1201 NEW YORK AVENUE, N.W., WASHINGTON, DC, 20005, US

(21) Appl. No.: 12/449,111

(22) PCT Filed: Jan. 22, 2008
(86) PCT No.: PCT/EP2008/050707

§ 371 Date: Nov. 12, 2009

(30) Foreign Application Priority Data
Jan. 23, 2007 (GB) 0701244.6

(51) Int. Cl. H04B 7/005; H04W 72/04

(52) U.S. Cl. 455/450; 455/522

(57) ABSTRACT

A method controls interference between a first and second communication system, each system having a base station and at least one use device. According to the method, in response to a trigger, a connection is set up between a first system user device and a second system base station. A maximum uplink power is allocated for the first system user device. Transmissions are halted between the first system user device and a first system base station. This means that the maximum uplink power is not exceeded and interference between the first system user device and the second system base station and user devices is minimized. The first system base station is a private pico/home base station and the second system base station is a public macro/micro base station.

### CROSS REFERENCE TO RELATED APPLICATIONS

This application is based on and hereby claims priority to PCT Application No. PCT/EP2008/050707 filed on Jan. 22, 2008 and GB Application No. 0701244.6 filed on Jan. 23, 2007, the contents of which are hereby incorporated by reference.

### BACKGROUND OF THE INVENTION

This invention relates to a method of controlling interference between first and second communication systems.

In 3rd generation partnership project (3 GPP) systems, universal mobile telecommunications (UMTS) operators have proposed so called home base stations, or pico base stations, i.e. plug and play base stations controlling basic radio network controller (RNC) functions, that are meant to be installed for indoor use, without necessarily knowing the whereabouts of neighboring cells, i.e. macro cells, micro cells, or other home base cells.

In this description, the term pico, or home base station is used to refer to the consumer installed 3 G base station and the terms micro and macro base stations refer to 3G networked base stations, not controlled by the consumer. Generally, macro base stations cover a wide area, typically several kilometers in radius in the urban environment and provide public access i.e. to all users supported by that operator. Micro base stations offer the same functionality, but cover a smaller area, typically small urban sites, such as large shopping complexes, or railway stations. Both macro and micro deployment require an expert installation where the sites are carefully chosen, typically a-priori radio planning is involved, and installation is by expert engineers who are able to make on-site adjustments. Home, or pico base stations cover a much smaller area, such as a single room, or single house and have ranges typically of a few 10's of meters, with typically theoretical free space range limits of 100 to 200 meters. Home, or pico stations mandate a user non-expert installation due to cost and practical constraints, since expert engineer time is too expensive and there are too few to support a large scale domestic deployment.

Each home base station covers a default area, which may be included within a macro cell area. Such a scenario requires the presence of adequate mechanisms for uplink power and orthogonal, or scrambling, code management. This is because the home base station has no lub interface, so is not synchronized with the rest of the

UMTS network and therefore may assign uplink power to its associated user devices, or user equipments (UEs), which is too high and which causes interference for uplink reception at the macro base station. Furthermore, the home base station may accidentally use the same downlink orthogonal code as the macro cell has allocated, therefore impairing correct signal reception for those UEs connected to the macro cell base station and falling within the coverage area of the home base station, and generating too much interference for the systems to work effectively. The latter phenomenon is due to orthogonal codes assignment, between home base station and macro base station, not being synchronized.

In a co pending GB application number 0700171.2 the problem of uplink power setup in the case of a home base station included within a macro cell has been addressed by allowing the home base station (HBS) to act as a logical UE at power up, so that the HBS achieves power synchronization with the Macro Node B, before allowing UEs to communicate using the HBS as a base station.

However, this still leaves a number of issues to be addressed. The HBS might be located further from the macro base station than the UE is, or the HBS might be in such a position as to be subject to path losses towards the macro base station, which are much higher than those affecting the UE. In this case the maximum uplink power assigned to the logical UE integrated in the HBS is too high for the actual UE trying to connect to the HBS. If the UE connecting to the HBS uses such maximum power, the power causes the overall uplink cell interference to increase beyond acceptable limits.

Another issue is that the interference scenario on the basis of which the maximum uplink power is calculated by the macro base station, such as the fact that the path loss between UE and HBS, at the moment when the logical UE built into the HBS tries to connect to the macro base station, changes over in time. Hence, a more frequent maximum uplink power update needs to be performed by letting the UE, which is connected to the HBS, connect for a short time to the macro cell. Managing assignment of orthogonal codes between macro base station and HBS has not been addressed to date.

### SUMMARY

The inventor proposes a method of controlling interference between first and second communication systems, each system comprising a base station and at least one user device, comprises in response to a trigger, setting up a connection between a first system user device and a second system base station; allocating a maximum uplink power for the first system user device; and halting transmissions between the first system user device and a first system base station, such that the maximum uplink power is not exceeded and interference between the first system user device and the second system base station and user devices is minimized.

Preferably, the method further comprises allocating a downlink orthogonal code to the first system user device from the first system base station; notifying the second system base station of the allocated code and comparing the allocated code with codes allocated by the second system base station; wherein the code allocated to the first system user device is changed if the result of the comparison is that that code has already been allocated by the second system base station.

Preferably, the allocated uplink power of the first system user device is notified to the first system base station and the first system base station keeps uplink power for all its user devices below the allocated maximum.

Alternatively, the first system user device ensures that it does not exceed the allocated maximum uplink power.

Preferably, the trigger comprises one of setting up a radio bearer between the first system base station and first system user device; and expiry of a periodic timer.

Preferably, the allocated maximum uplink power at the first system base station is the minimum of the allocated maximum uplink power of all user devices in the first communication system.

Preferably, a pilot channel from the first system base station is subject to a time shift of a predetermined amount.

Preferably, the first system user device notifies the first system base station of its inability to decode a pilot channel, where after the first base station applies the time shift.

The inventor also proposes an apparatus providing the method and a communication system embodying the method.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 illustrates a typical network arrangement in which the proposed method is applied; and

FIG. 2 is a flow chart illustrating the proposed method in the network of FIG. 1

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

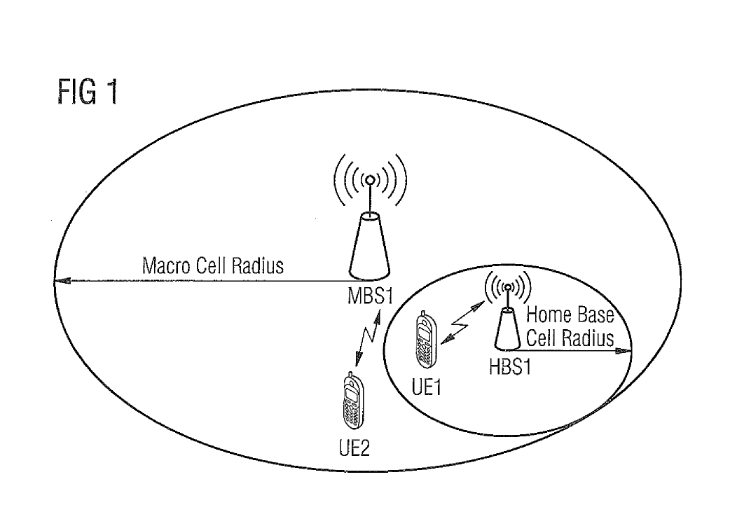

FIG. 1 illustrates an example of the method and apparatus proposed by the inventor. The apparatus may be a UMTS network formed by two systems, for simplicity shown as one home base station HBS 1 and associated UE UEI and one macro base station MBS 1 and associated UE UE2, although each system base station can handle many UEs, A cell area HAI of the home base station cell and a cell area MAI of the macro base station cell completely overlap and HAI falls within MAI. UE2 is connected to the macro base station MBS 1 and UEI is connected to the home base station HBSI, such that uplink signals of UEI may create interference at the macro base station. Moreover, downlink signals from HBSI to UEI may create interference at UE2. With this scenario there may be problems of maximum uplink power setup for UEI and orthogonal code assignment for downlink transmission from the home base station to UEI.

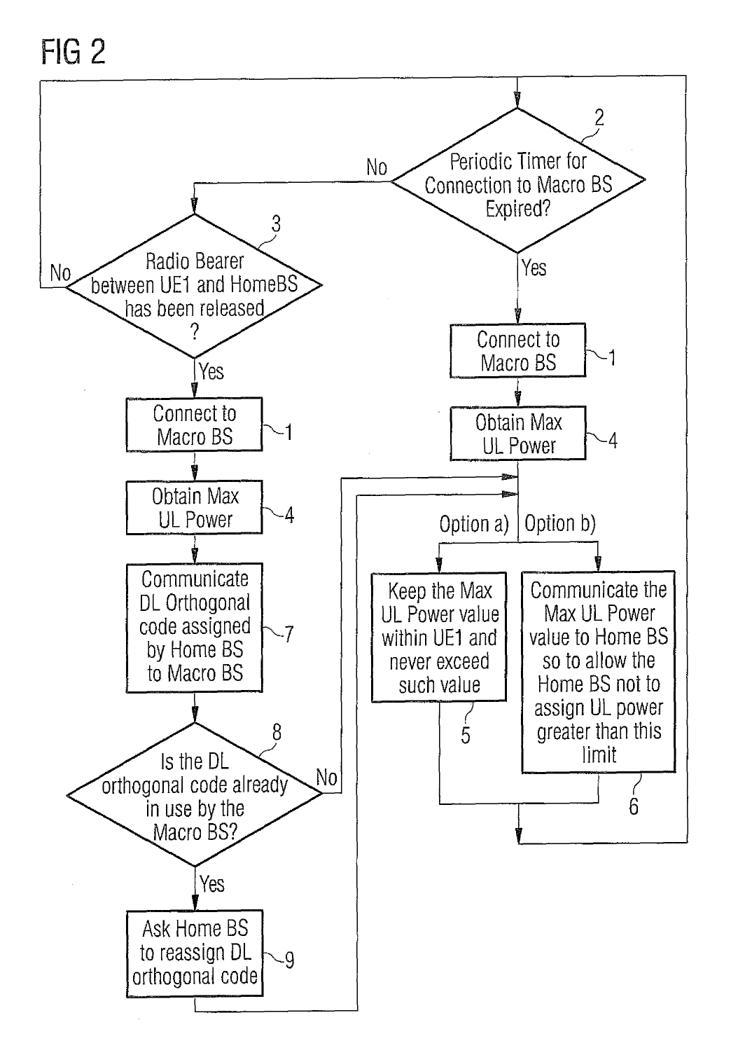

With reference also to FIG. 2, whilst UEI is connected to HBSI, UEI tries to connect 1 to the macro base station for uplink power and orthogonal codes management purposes only. This may be done either periodically 2, or just after a radio bearer is assigned 3 from the home base station to UEI and released, along with an assigned scrambled code. In the latter case of radio bearer assignment, the attempt to connect to the macro base station is performed before communication between UEI and HBS 1 has started.

Once connected to the macro base station, UEI obtains 4 the maximum uplink power to be used within the macro cell by carrying out closed loop power control. In the example where a time has expired, this power can be used in two ways. Either, UEI keeps 5 within the value for the maximum uplink power and never exceeds this value, even if the HBS asks to raise the uplink power beyond such a limit, or UEI communicates the maximum uplink power value to the home base station, so that HBS 1 treats this limit as the value beyond which the uplink power for UEI shall not be raised and no greater uplink power is assigned.

In the case where a radio bearer has been released and once connected 1 to the macro base station, UEI also communicates 7 to the macro base station the downlink orthogonal code assigned by the home base station for downlink communication. Since there is no connection between the RNC function of the first and second system base stations, it is possible for the same scrambling code to be allocated to different user devices in the first and second communication systems. If the macro base station MBSI discovers 8 that this code is already used by the macro base station for downlink communication with another UE, a message 9 is sent from the macro base station to UEI asking it to forward to the home base station a downlink orthogonal code reassignment. UEI therefore requests that the home base station modifies the downlink orthogonal code initially employed. The main problem arises with unscrambled pilot channels transmitting periodically for the UE to synchronize with the network. If pilot channels from the MBS and HBS send at the same time, then it is not possible for the UE to connect. This is dealt with by allowing the synchronization from the HBS to the first UE to drift in time, so that the clash does not endure. The MBS is more accurate, so the imposed drift removes the overlap and allows the pilot channels for each system to be decoded. If the UE notices that it cannot decode a pilot signal, it notifies the HBS which applies the offset to the time synchronization code. Typically, this is either an addition or removal of a delay of a predetermined amount to decouple the two systems.

A non-limiting example of an access architecture than may be used for at least one of the network is based on a concept known as long term evolution (LTE). A particular example of such systems is the Evolved Universal Terrestrial Radio Access (E-UTRA). An Evolved Universal Terrestrial Radio Access Network (E-UTRAN) having E-UTRAN Node Bs (eNBs) which are configured to provide base station and control functionalities. In these systems various functions that have been conventionally handled based on centralized control can be handled in a distributed manner. This kind of distributed architecture is sometimes referred to as a “flat architecture”. For example, the eNBs nodes can provide independently E-UTRA features such as user plane radio link control/medium access control/physical layer protocol (RLC/MAC/PHY) and control plane radio resource control (RRC) protocol terminations towards the user devices.

The advantages of the proposed method and apparatus include dynamic management of the maximum uplink power used by UEs connected to a home base station and located within a macro cell; and dynamic management of downlink orthogonal codes assigned by a home base station to a UE located within a macro cell. The first of these allows situations to be avoided where the interference, or the path loss scenario affecting the signal strength received by the UE connected to the base station, changes in such a way as to require high uplink transmission power that could generate such high interference at the macro base station as to impair correct reception of other uplink signals.

The second of these addresses the problem of possible conflicts in downlink orthogonal code assignment between the macro base station and the home base station. If left unresolved, this problem can lead to lack of communication between the UE and the macro or home base station on the downlink channel where the conflicting orthogonal code is used.

The required data processing functions may be provided by one or more data processors. All data processing may be provided in a processing unit provided in an access system, or distributed across several data processing modules. The above described functions may be provided by separate processors or by an integrated processor. An appropriately adapted computer program code product or products may be used for implementing the embodiments, when loaded on an appropriate processor, for example in a processor of an access system controller or a user device. The program code product for providing the operation may be stored on and provided by a carrier medium such as a carrier disc, card or tape. A possibility is to download the program code product to the mobile device via a data network.

It is noted that whilst embodiments have been described in relation to user devices such as mobile terminals, embodiments of the present invention are applicable to any other suitable type of apparatus suitable for communication via a plurality access networks.

It is also noted that although certain embodiments were described above by way of example with reference to certain exemplifying architectures for wireless networks, technologies and standards, embodiments may be applied to any other suitable forms of communication systems than those illustrated and described herein. It is also noted that the terms network or subnetwork are understood to refer to any network configured for enabling wireless communication for a user equipment.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-19. (canceled)

20. A method of controlling interference between first and second communication systems, each system comprising a base station and at least one user device, the method comprising:
in response to a trigger, setting up a connection between a first system user device and a second system base station;
allocating a maximum uplink power for the first system user device, the maximum uplink power being allocated via the second system base station;
setting up a connection between the first system user device and a first system base station; and
controlling transmissions between the first system user device and the first system base station, such that the maximum uplink power of the first system user device is not exceeded and interference between the first system user device and the second system base station and user devices of the second communication system is minimized, wherein
the first and second base stations are connected to the same network and operate using a common communication protocol such that the first system user device has a capability to connect to either the first or second base station,
the first base station is not synchronized with the network such that the network is unable to provide the first base station with power control.

21. A method of controlling interference between first and second communication systems, each system comprising a base station and at least one user device, the method comprising:
in response to a trigger, setting up a connection between a first system user device and a second system base station;
allocating a maximum uplink power for the first system user device; and
controlling transmissions between the first system user device and a first system base station such that the maximum uplink power of the first system user device is not exceeded and interference between the first system user device and the second system base station and user devices of the second communication system is minimized.

22. A method according to claim 21, wherein the method further comprises:
allocating a downlink orthogonal code to the first system user device from the first system base station;
notifying the second system base station of the code allocated;
comparing the code allocated with codes allocated by the second system base station; and
changing the code allocated to the first system user device if the code allocated to the first system user device has already been allocated by the second system base station.

23. A method according to claim 21, wherein
the maximum uplink power allocated for the first system user device is notified to the first system base station as an allocated maximum, and
the first system base station keeps uplink power for all first system user devices below the allocated maximum.

24. A method according to claim 21, wherein the first system user device ensures that it does not exceed the maximum uplink power.

25. A method according to claim 21, wherein the trigger comprises one of setting up a radio bearer between the first system base station and the first system user device and expiry of a periodic timer.

26. A method according to claim 21, wherein the first system base station is allocated a maximum uplink power equivalent to a lowest maximum uplink power of all user devices in the first communication system.

27. A method according to claim 21, wherein a pilot channel from the first system base station is subject to a time shift of a predetermined amount.

28. A method according to claim 27, wherein the first system user device notifies the first system base station of its inability to decode the pilot channel, where after the first system base station applies the time shift.

29. An apparatus for a communication system, the apparatus being configured to, in response to a trigger, set up a connection between a first subsystem user device and a second subsystem base station; allocate a maximum uplink power for the first subsystem user device; and control transmissions between the first subsystem user device and a first subsystem base station to avoid exceeding the maximum uplink power of the first subsystem user device and to reduce interference between the first subsystem user device and the second subsystem base station and user devices of the second subsystem.

30. An apparatus according to claim 29, wherein the apparatus is further configured to allocate a downlink orthogonal code to the first subsystem user device from the first subsystem base station; to notify the second subsystem base station of the code allocated; to compare the code allocated with codes allocated by the second subsystem base station, and to change the code allocated to the first subsystem user device if the code allocated to the first system user device has already been allocated by the second system base station.

31. An apparatus according to claim 29, wherein the first subsystem user device notifies, as an allocated maximum, the first subsystem base station of the maximum uplink power allocated for the first subsystem user device.

32. An apparatus according to claim 31, wherein the first subsystem base station is configured to keep uplink power for all first subsystem user devices below the allocated maximum.

33. An apparatus according to claim 29, wherein the first subsystem user device is configured to ensure that it does not exceed the maximum uplink power.

34. An apparatus according to claim 29, wherein the trigger comprises one of setting up a radio bearer between the first subsystem base station and the first subsystem user device and expiry of a periodic timer.

35. An apparatus according to claim 29, wherein the first subsystem base station is allocated a maximum uplink power equivalent to a lowest maximum uplink power of all user devices in the first subsystem.

36. An apparatus according to claim 29, wherein a pilot channel from the first subsystem base station is subject to a time shift of a predetermined amount.

37. An apparatus according to claim 36, wherein the first subsystem user device is configured to send a notification to the first subsystem base station of its inability to decode the pilot channel, and wherein the first subsystem base station is configured to apply the time shift in response to the notification.

38. A communication system comprising:
a second subsystem base station;
a plurality of user devices of the second subsystem;
a first subsystem user device to set up a connection with the second subsystem base station in response to a trigger, such that a maximum uplink power is allocated to the first subsystem user device, and
a first subsystem base station to communicate with the first subsystem user device with transmissions controlled to avoid exceeding the maximum uplink power of the first subsystem user device and to reduce interference between the first subsystem user device and the second subsystem base station and user devices of the second subsystem.

39. A computer readable storage medium storing a program for controlling at least a computer to perform a method of controlling interference between first and second communication systems, each system comprising a base station and at least one user device, the method comprising:
in response to a trigger, setting up a connection between a first system user device and a second system base station;
allocating a maximum uplink power for the first system user device; and
controlling transmissions between the first system user device and a first system base station such that the maximum uplink power of the first system user device is not exceeded and interference between the first system user device and the second system base station and user devices of the second communication system is minimized.
